(19) United States
(12) Patent Application Publication
(10) Pub. No.: US 2007/0257774 A1
(43) Pub. Date: Nov. 8, 2007

(54) Method and Device for Delivery or Obtaining of a Good

(76) Inventors: Martin Stumpert, Hochspeyer (DE); Joerg Christian Ewert, Erkelenz (DE)

Correspondence Address: ERICSSON INC., 6300 LEGACY DRIVE, M/S EVR 1-C-11, PLANO, TX, 75024, US

(21) Appl. No.: 10/595,177

(22) PCT Filed: Sep. 19, 2003
(86) PCT No.: PCT/EP03/10464

§ 371 Date: Feb. 22, 2007

(51) Int. Cl. G08B 5/22

(52) U.S. Cl. 340/7.1

(57) ABSTRACT

A method for delivery of a good for a first entity (C100) is disclosed. The method comprises the steps of transporting the good by a second entity (D100) to a storage (S120) which is locked by a lock system (S110), communicating a notification to the first entity (C100) for requesting an unlocking of the lock system (S110) for the second entity (D100), sending a message via a mobile telecommunication system from the first entity (C100) to the lock system (S110) for unlocking the lock system (S110), unlocking the lock system (S110) based on the received message, opening the storage (S120), and transferring the good from the second entity (D100) to the opened storage (S120). Furthermore, a method for obtaining a good from a storage (S120) of a first entity (C100) is disclosed and devices that allow the implementation of the methods.

### FIELD OF THE INVENTION

The present invention relates to a method for delivery and/or obtaining of a good and to a lock system that can be remotely controlled.

### BACKGROUND OF THE INVENTION

In traditional shopping, wherein a customer acquires a good personally at the facilities of the merchant, the customer has two alternatives for the transportation of the acquired good to the premises of the customer. Firstly, the customer can directly carry away the good. Secondly, a delivery service can be used for the transportation of the good.

For delivering a good to a customer, a delivery service fetches the good at a location specified by the merchant. This location is typically the address of the merchant but can be alternatively e.g. an address of a facility where the good is produced or stored. For transportation of the good to an address of the customer, the delivery service may use one or more suited transportation vehicles like cars, trains, or ships. Examples for a delivery service are private or federal post companies.

With the introduction of modern communication tools like phone, fax, or Internet, the ordering and buying of good does no longer require the personal attendance of the customer at the merchant. Due to the local separation of the customer and the merchant, the number of potential customers for the merchant and the number of merchants for the customer is dramatically increased. In addition, the separation leads to the situation that the customer typically does not personally attend at the merchant to carry away the acquired good but to use a delivery service.

A delivery service may be in case of acquired software a sending of the software to the personal computer of the customer. However, this kind of purely electronic delivery service is not regarded further because it is restricted to specific software products. The term “good” is used in the following for physical goods where a physical transportation is needed for delivering the good to an entity like a customer. Thus, a good can be a parcel but also software stored on a CD-ROM or the like.

For a private customer, the address of the customer is typically his private home address. However, the delivery fails if the customer is not present at his home address in order to receive the good from the delivery service.

Some delivery services may try to deliver the good to neighbors which enhances the probability for handing over the good. However, the handing over of goods to non-authorized people like neighbors may be problematic from a legal perspective. In order to overcome legal restrictions, the customer may specify several authorized addresses for the delivery. However, multiple addresses require more effort for the customer because he has to select the multiple addresses and has to trust them. Furthermore, the delivery service has to administer the multiple addresses and to manage authorization for verifying that a specified address is authorized. Beside the larger effort for administration and management, the planning of the delivery routes gets more problematic, e.g. simply due to increased number of addresses but also because it is rather unpredictable how many of the specified addresses of the customer the delivery service has to approach for a delivery. Especially if multiple goods to different customers have to be delivered, the unpredictable number of addresses that have to be approached may cause temporal uncertainties in the routing planning.

Location based services (LBS) can be used in order to locate the location of a mobile phone of a mobile telecommunication system like the Global System for Mobile communication (GSM), the General Packet Radio System (GPRS) or the Universal Mobile Telecommunication System (UMTS). For increasing the probability of reaching the customer, the delivery service may transport the good to the current location of the customer carrying a mobile phone being localizable by the delivery service via LBS. However, such a solution is a drawback because the customer has to give in some privacy due to the personal localization. In addition, the customer may not want or is not able to accept the hand over of the good at his current location, e.g. when being at his working place or when traveling.

A delivery service may also hand over the good to a central intermediate storage system where the customer can pick it up. An example for a central intermediate storage system is Tower24 that is reachable for delivery services and for customers 24 hours a day, see http://www.tower24.de as of 17. Jul. 2003. An inherent drawback of a commercially operated central intermediate storage system is that it is rare, i.e. there is so far only one central intermediate storage in only one German town. Thus, unless the customer is by chance close to the location of the central intermediate storage, the customer in general has to make a large detour from his current position to the central intermediate storage for obtaining the good, which is inconvenient, time and resource consuming and thus not acceptable for most customers. In addition, in order to be profitable, the customer will have in the end to pay for the service offered by the commercially operated intermediate storage system.

### SUMMARY OF THE INVENTION

It is an object of the present invention to provide methods and devices, which overcome the aforementioned shortcomings and drawbacks.

This object is achieved by the method as described in claim 1. Furthermore, the invention is embodied in a method for remotely controlling a lock system as described in claim 13, a remotely controllable lock system as described in claim 18, and a computer program as described in claim 26. Advantageous embodiments are described in the further claims.

The invention discloses a method for delivery of a good for a first entity like a customer. A first entity is to be understood as the recipient of the good like an orderer of the good. The first entity can be a person or any other entity for which the good is to be delivered for. For sending, receiving, and processing of messages, the first entity may use an appropriate communication device.

The method can be triggered by an explicit order for the good by the first entity at a merchant or can be triggered by other incidences like a distribution scenario without explicit order by the first entity, e.g. due to an order by a merchant to a second entity for a delivery for multiple first entities like multiple customers for advertisement purpose.

For the delivery, a second entity transports the good to a storage of the first entity. The second entity, e.g. a delivery service, is to be understood as an entity that delivers the good for the first entity and may use an appropriate communication device for sending, receiving, and processing of messages and an appropriate transportation vehicle for transporting the good. A delivery address may be provided to the second entity prior to the transport such that the second entity is informed about where to deliver the good.

The storage is locked by a lock system remotely controllable by the first entity. For informing the first entity to unlock the lock system for the second entity, a notification is communicated to the first entity for requesting the unlocking of the lock system for the second entity. The communication of the notification is preferably initiated when the delivery service arrives at the storage/lock system and can comprise information based on that the first entity can recognize the second entity. The communication to the first entity may further indicate the proximity of the second entity and the storage and lock system.

For remotely unlocking the lock system, the first entity sends a message via a mobile telecommunication system like a GSM, GPRS or UMTS network to the lock system. Based on the message, the lock system is unlocked such that the storage can be opened and the good can be transferred from the second entity to the opened storage. After transferring of the good into the storage, the storage can be closed and the lock system can be locked again. Locking the closed storage prevents access to the delivered good for non-authorized entities, e.g. a thief or the second entity after the handing over, i.e. the transfer to the storage. If the storage is arranged such that it does not allow access to the good in the storage, e.g. if the storage is chute-like, the steps of closing and locking can be omitted. Opening and closing the storage and locking the lock system can be executed manually by the second entity, automatically by the lock system based on pre-stored instruction data instructing the lock system about the automatically executable processes for opening, closing, and/or locking or remotely by the first entity by communicating instruction information from the first entity to the lock system. For communicating the instruction information one or more further messages from the first entity may be sent to the lock system for an explicit control of the first entity about one or more of the opening, closing and locking steps. Alternatively, the instruction information for one or more of the aforementioned steps may be comprised already in the message for unlocking thus saving messaging effort.

The usage of a mobile communication system with its large, nearly unlimited coverage gives the first entity most flexibility and is thus superior compared to a short-range wireless communication technique used for remote keys that requires the first entity to stay within the short transmission range in the order of about 100 meters of the short-range wireless communication technique. Furthermore, mobile communication systems are widely deployed and publicly accepted thus easing the implementation of the method.

The method provides that the first entity is in better control about the delivery process. For the delivery, the first entity does not have to meet locally with the second entity for handing over the good from the second entity to the first entity. Thus, it is up to the first entity to decide whether it attends or stays away and controls the delivery process remotely thus improving privacy aspects and flexibility. The delivery success can be increased for the first entity and the second entity because the handing over of the good is no longer depending cn the personal attendance of a person accepting the consignment from the second entity but only on the availability of the first entity acting remotely. Thus, the first entity may grant access to the storage when being at work or when traveling. Compared to centralized intermediate storage systems, the first entity is in control about the access to the storage, which is of advantage as the first entity is no longer bound to restrictions prescribed by the instance operating the central intermediate storage system. Examples are temporal restrictions like a maximum storage time for a good, dimensional restrictions like a maximum size of a good, or environmental restrictions for temperature sensitive or hazardous goods. The remotely controllable lock system may be arranged to be attachable to one or more further storages thus further improving the flexibility of the method as e.g. a storage may be selected that fits to the characteristics of the good or the preferences the first entities. The first entity may remotely control also one or more further lock systems attached to one more storage systems according to the invention, e.g. to grant access to a storage being locked by multiple remotely controllable lock systems or to provide to the second entity a choice to select a storage in case the first entity controls access to multiple storages according to the invention.

According to a preferred embodiment, the method further comprises the step of communicating a delivery address related to the storage or the lock system to the second entity during the transport. The delivery address informs the second entity where to deliver the good. The delivery address can be a location like geographical coordinates or a name of a location, e.g. country, town, and street.

In case, multiple storages are located at the specified location, the delivery address may comprise information identifying the storage or the lock system to distinguish the storage to which the good is to be delivered to from the further storages. The delivery address may be communicated to the second entity e.g. from the first entity or a further entity like a merchant ordering the second entity to deliver the good for the first entity. Communicating the delivery address during the transport of the good can be especially beneficial for moving storages or lock systems. Location and identification information may be communicated via one or more messages like SMS or via a mobile phone call or via further mobile transmission techniques.

In a corresponding manner, the invention can be applied for obtaining a good from the first entity.

A method for obtaining a good from a first entity is disclosed. In a first step, a second entity travels to a storage comprising the good. The storage is locked by a lock system. A notification is communicated to the first entity for requesting an unlocking of the lock system for the second entity. Based on the notification, a message is sent via a mobile telecommunication system from the first entity to the lock system for unlocking the lock system. Based on the message, the lock system is unlocked. Furthermore, the storage is opened and the good is transferred from the opened storage to the second entity, e.g. manually by the second entity or an automatic transfer mechanism.

Correspondingly, the remote unlocking of the lock system provides that the first entity controls the obtaining of the good from the storage by acting remotely thus overcoming the need that the first entity and the second entity have to meet locally to hand over the good. Further preferred embodiments and advantages mentioned for the method for delivery, apply in a corresponding manner to the method for obtaining.

Correspondingly, an address informing the second entity where to obtain the good can be communicated before the second entity starts it's traveling to the storage or during the traveling.

According to a preferred embodiment, information for notifying the first entity is obtained by the second entity. Based on the information for notifying, the second entity can get in contact with the second entity for informing the second entity about the request for unlocking. As it is typically of advantage that the request is made when the second entity is in close proximity to the storage, short range communication techniques may be used to transfer the information for notifying from the storage or lock system to the second entity. Examples for information for notifying are an address of a communication device of the first entity like an MSISDN number of a mobile phone.

According to another preferred embodiment, the method further comprises the step of authenticating at least one of the first entity, the second entity, and the lock system, which makes the method more secure. Authentication of a first entity to a further entity can be achieved by providing authentication information like a user-name and password associated with the first entity to the further entity which subsequently verifies the provided authentication information by checking if the provided authentication information match to the stored authentication information, e.g. if a provided user-name and a provided password pair match to a stored user-name and a password pair. Further authentication methods e.g. based on biometrics are possible. An authentication can be achieved on device level, e.g. an authentication of a communication device corresponding to the first entity versus a communication device corresponding to the second entity. For authenticating a first device by a second device, an identity identifying the first device can be communicated to the second device, which can subsequently authenticate the first device by checking if the received identity matches to authentication information stored at the first device. Authentication can be furthermore on personal level, e.g. in order to prove that an operator of a device is entitled to operate the corresponding device and/or to execute a step of the method. Personal authentication can be e.g. implemented via entering personal authentication information like a personal identification number (PIN) or a fingerprint into a communication device. A person can be authenticated by comparing the entered personal authentication information to stored personal authentication information like a stored PIN and a stored finger print and checking if both entered and stored information match. If they do not match, the authentication fails, if they match the authentication is successful. From a security point of view it can be beneficial that a mutual authentication between devices and/or persons is achieved, e.g. between the first entity and second entity or between the lock system and the first and/or second entity.

According to another preferred embodiment, the method further comprises the step of verifying an authorization of at least one of the first entity and the second entity for the unlocking. Verification of an authorization further enhances the security as it can prevent unauthorized access to the lock system and storage. Authorization information indicating an authorization of the first and/or second entity to operate the lock system can be provided to the lock system, e.g. via or in conjunction with the step of receiving the message for the unlocking. The lock system can verify the authorization information e.g. by checking if the authorization information matches to stored authorization information and can unlock the lock system if both, received and stored authorization information match.

Before unlocking the lock system, authorization information can be verified by the lock system which makes the method more secure as an unauthorized access to the storage can be prevented.

According to another preferred embodiment, the method further comprises the step of verifying restriction information for the unlocking. Restriction information can further restrict the unlocking, e.g. the lock system can check if received restriction information match to predefined or current conditions and can perform the unlocking according to the outcome of the check, e.g. to unlock the lock if the conditions are fulfilled. The restriction information can be encrypted to prevent a change to the restriction information, e.g. for the second entity. The lock system can be adapted to execute a decryption of the encrypted restriction information for unlocking the lock by using an appropriate decryption key. Correspondingly, the authentication and/or authorization information may be encrypted and decrypted.

According to another preferred embodiment, the method further comprises the step of supervising one or more steps of the method for delivery. Supervising of one or more steps of the delivery makes the delivery more secure. The first entity, the second entity, the lock system, and/or a third party can use an appropriate detector recording information about said one or more steps for the supervision, which can be e.g. used to prove the delivery or non-delivery of the good.

According to another preferred embodiment, the storage is an interior of a vehicle. A vehicle is of advantage as it can move, i.e. it can follow the location of the first entity such that the first entity does not have to travel far to reach the vehicle. An interior is to be understood as a closed room of a vehicle that is accessible by the second entity for the delivery of the good for the first entity according to the present invention. The interior can be within the vehicle or attached to the vehicle like a passengers compartment or a roof box, respectively.

According a preferred embodiment, the storage is a trunk of a car. According to the terminology introduced above, the car is an example for a vehicle and a trunk is an example for an interior of a vehicle. Further examples for a vehicle are a ship, a plane, a train, etc. The use of a car is advantageous as most people have a car. A person's car is typically close to this person's location, e.g. when being at work, and will be accessed anyhow, e.g. after work or after making a travel, such that no detours are necessary for picking up the good.

Another advantage of a car is that the first entity can transport the good in a comfortable way to his home or other wanted address without the need for reloading the good into a further vehicle for the transport, because the good is already in the transport vehicle. Especially the trunk of a limousine, sometimes also called sedan, allows no or only very restricted access to the passenger's compartment compared to solutions where the passenger's compartment is directly accessed for placing the good, e.g. by remotely opening a window or door of the car or the roof of a convertible. Thus, the usage of the trunk offers a good compromise between low implementation effort, good comfortableness and reasonably security aspects for the first entity who typically does not want that someone else accesses the passengers compartment of his car.

According to a preferred embodiment, the method further comprises the step of remotely locking the lock system. Thus, the first entity does not only control the unlocking but also the locking of the lock system. The remote locking can be achieved by sending a further message from the first entity via a mobile communication system to the lock system for instructing the lock system to lock. Based on the received instruction information, the lock system locks. Alternatively or in addition, the received instruction information can be received via the message for unlocking, e.g. the first entity may specify a time limit after that the lock system has to lock, thus saving extra messages.

The method for delivery and the method for obtaining can be combined, e.g. the second entity may deliver a good to a storage according to the method for delivery and obtain a further good from the same or a further storage according to the method for obtaining. The combination can be very preferable for a second entity offering both deliverance and the pick-up service of goods. An example is the deliverance of a filled container like a filled deposit or refund bottle and the obtaining of a similar but empty container like an empty deposit or refund bottle. Another example is the obtaining of a filled container and the delivering of a similar but empty container. In case the deliverance and the obtaining are performed at the same storage or at storages closely located, one notification message may be sent for informing the first entity of the unlocking request. One message for unlocking can be sent in case the same storage is used for deliverance and obtaining. In case two storages are used, one message for unlocking can be sent if both storages are locked by the same lock system thus reducing messaging effort.

The invention comprises a method for remotely controlling a lock system as described in the following. The method comprises the steps of receiving at the lock system a message for operating a leck of the lock system. The message is received from a first entity via a mobile communication system. The lock system generates a signal for operating the lock according to the message and communicates the signal to the lock. According to the signal, the lock is operated. Examples for the operation of the lock are an unlocking or locking of the lock. The lock system can be used for locking or unlocking a storage as described before e.g. for delivery of a good to the storage and/or for obtaining a good from the storage. Furthermore, the lock system can be used to lock entities not located in a storage, e.g. in order to protect a bike from being stolen, and access to said entity can be granted by the first entity by unlocking the lock system.

According to a preferred embodiment, the method for remotely controlling a lock system further comprises the step of authenticating the first entity by the lock system for the operating the lock. Alternatively or in addition, the lock system can verify an authorization of the first entity for the operation.

The message for operating the lock can be proxied via a second entity like a delivery service. For this case, the method for remotely controlling a lock system preferably further comprises the step of authenticating the second entity and/or verifying an authorization of the second entity by the lock system for operating the lock.

According to a preferred embodiment, the method for remotely controlling a lock system further comprises the step of verifying restriction information by the lock system for operating the lock.

According to a preferred embodiment, the method for remotely controlling a lock system further comprises the steps of receiving by the lock system from a detector a signal indicating information about the lock and/or about the environment of the lock, generating by the lock system a further message based on the detector signal for indicating said information to the first entity, and communicating the further message to the first entity. The detector signal may originate from a detector connected to the lock indicating a status of the lock, e.g. being locked or being unlocked or defect, thus informing first entity about the status of the lock. A camera or any other kind of appropriate detector can monitor the environment of the lock. The monitored information can be transferred via the lock system to first entity thus informing the first entity about the environment, e.g. to supervise a delivery or obtaining of a good by a second entity. The lock system can convert the received signal into information interpretable for the first entity.

The invention is furthermore embodied in remotely controllable lock system, which is described in the following.

The remotely controllable lock system comprises a receiving unit, a transmission unit, a processing unit, and a lock. The receiving unit is adapted to receive via a mobile telecommunication system a message for operating the lock from a first entity. The processing unit is adapted to process the message for generating a signal for operating the lock according to the message. The transmission unit is adapted to communicate the signal to the lock and the lock is adapted to be operated according to the signal.

According to a preferred embodiment of the lock system, the processing unit is adapted to generate the signal for operating the lock based on a key. The key can be received via the receiving unit from the first entity. The processing unit can be adapted to verify if the key matches to the lock, e.g. by checking if a key serial number matches to a lock serial number, before generating or communicating the signal for the operation to the lock. If the key does not match, an error message may be communicated to the first entity and the steps of the generation and the transmission of the signal for the operation of the lock may be omitted thus improving security and functionality.

According to another preferred embodiment of the lock system, the processing unit is adapted to authenticate the first entity and/or to verify an authorization of the first entity for the operation.

According to another preferred embodiment of the lock system, the processing unit is adapted to verify restriction information for the operation of the lock.

According to another preferred embodiment of the lock system, the lock system comprises a detector for a supervision of the lock or the environment of the lock.

According to another preferred embodiment of the lock system, the lock is a lock of a vehicle, e.g. of an electronic lock of a car.

According to another preferred embodiment of the lock system, the lock system is portable. Compared to an integrated or permanently fixed lock system, a portable lock system has the advantage that it can be subsequently attached to various entities like a first storage and a second storage or to a storage and to the ends of a chain. An example for a portable lock system is a remotely controllable padlock.

According to another preferred embodiment of the lock system, the receiving unit, the processing unit, and the transmission unit are part of a communication device with mobile phone functionality compliant with existing and/or future mobile phone standards. A communication device with mobile phone functionality eases the implementation of the method as well as the introduction and acceptance of the lock system as mobile phones are widely deployed and compatible with mobile telecommunication systems. It further supports the operation of a lock system that is attached or attachable to a mobile entity.

The present invention also concerns a computer program comprising portions of software codes in order to implement the method as described above when operated by a processing unit of a lock system. The computer program can be stored on a computer readable medium. The computer-readable medium can be a permanent or rewritable memory within the lock system or located externally. The computer program can be also transferred to the lock system for example via a cable or a wireless link as a sequence of signals.

The computer program is loadable in a processing unit of a lock system and comprises code adapted to process a message for operating a lock of the lock system received via a mobile telecommunication system from a first entity, to generate a signal for operating the lock according to the message, and to initiate a communication of the signal via an appropriate transmission unit to the lock for the operation of the lock. Correspondingly, the computer program can comprise code adapted to process a key, an authentication, a verification of an authorization and/or of restriction information. It further can be adapted to process signals received from a detector and to further initiate a communication of the information represented by said signals to the first entity, e.g. for supervision purpose.

In the following, detailed embodiments of the present invention shall be described in order to give the skilled person a full and complete understanding. However, these embodiments are illustrative and not intended to be limiting, as the scope of the invention is defined by the appended claims.

### BRIEF DESCRIPTION OF THE FIGURES

FIG. 1 shows an embodiment for an order and delivery scenario according to the invention;

FIG. 2 shows embodiments of message exchanges for the notification and the remote unlocking;

FIG. 3 shows a further embodiment for a delivery;

FIG. 4 shows a first embodiment of the lock system;

FIG. 5 shows a second embodiment of the lock system in a locked (a, c) and unlocked (b) status.

### DETAILED DESCRIPTION OF THE INVENTION

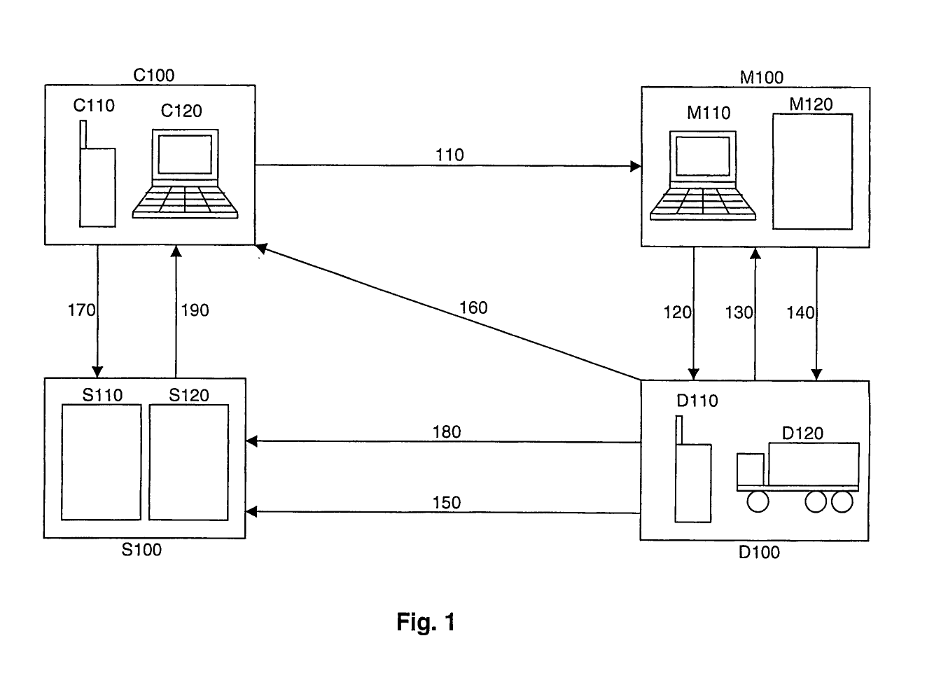

FIG. 1 shows an order and delivery scenario according to an embodiment of the invention. The customer C100 as an example for a first entity uses e.g. a personal computer C120 for an online order of a good in the Internet. The customer C100 orders the good via message 110 sent to an online ordering facility M10 at the merchant M100. With the order, the customer C100 can provide a delivery address for locating and identifying the storage S120 and lock system S110 and information that allows the notification of the customer C100 to request unlocking of the lock system C110. An example for a delivery address for delivering a good to a customer's car as an example for the storage S120 are geographical coordinates or a name of the location where the car is parked and a car plate for identifying the car. An example for notification information is a MSISDN number of a mobile phone C110 of the customer C100.

The online ordering facility M110 can check the availability of the good at a merchant's storage M120 and can confirm the order to customer C100 e.g. by sending a confirmation message to the customer C100 (confirmation message not shown). Subsequently, the online ordering facility M110 sends via message 120 an order to a delivery service D100 as an example for a second entity using as communication device a mobile phone D110. In this example, the delivery service D100 uses a truck D120 as transportation vehicle for the good and drives as indicated by arrow 130 to the storage M120 in order to pick up the good from the merchant M100 as indicated by arrow 140. According to the present example, the merchant M100 forwards the delivery address and the notification information received from the customer C100 to the delivery service D100 such that the delivery service D100 knows where to deliver the good and whom to contact for requesting the unlocking. When the delivery service D100 arrives at the location S100 according to the delivery address, the delivery service D100 notifies the customer C100 by sending a message 160 e.g. via a Short Message Service (SMS) to or by calling the customer C100 on his mobile phone C110. For unlocking the lock system S110 of the storage S120, the customer C100 sends a message 170 via a mobile communication system. The message 170 can be sent from the mobile phone C110 as depicted or from a further device that is capable of sending a message 170 via a mobile telecommunication system to the lock system S110 for the unlocking. Based on the message 170, the lock system S110 unlocks, the merchant D100 opens the storage S120 and transfers the good into the opened storage S120 as indicated by arrow 180. Then, the storage S120 is closed and the locking system S110 is locked. The successful delivery can be confirmed to the customer C100, e.g. by sending a confirmation message 190 from the locking system S110 to the mobile phone C110 of the customer C100. One or more further confirmation messages to inform the customer C100 that the unlocking or the locking of the lock has been successfully (or not successfully) executed by the lock system S110 can be sent from the lock system S110 to the communication device C110 of the customer C100.

The example described above is a typical order and delivery scenario according to the invention and is not to be understood as limiting. Especially, the communication devices depicted and described in conjunction with FIG. 1 or the transportation means or storages may be implemented differently. Examples for further communication devices are laptop computers or smart phones, for further transportation means of the delivery service D100 cars, planes, ships, bikes or combinations thereof, and for the storage S120 an interior of a car, a ship, a plane, or a box equipped with a lock system according to the invention may be used.

Goods can be solid, fluid, or gaseous. Examples for solid goods are parcels or containers, an example for a fluid good is fuel and for a gaseous good auto-gas. A storage should be adapted to the characteristics of the delivered good, i.e. it should be arranged to appropriately store a delivered good, or in case of obtaining, store a good in an appropriate manner before it's transfer to a pick-up service as an example for a second entity according to the invention. Examples for such storages are a trunk of a car for parcels, a fuel tank of a car for fuel, and a gas tank of a car for auto-gas.

Although depicted as two separate entities at different locations, the merchant M100 and the delivery service D100 can be one business entity and/or located at one location. For a delivery scenario without an explicit order by the customer, e.g. for advertisement deliveries, the order message 110 can be omitted.

A delivery address and notification information may be provided to the delivery service D100 as described by an explicit order from the customer C100 via the merchant M100. Alternatively, these data can be already available at the merchant M100 based on a merchant's database and can be given to the delivery service D100. For storages S120 that may change their delivery address, it is, however necessary to update the delivery service D100 with the current delivery address of the storage S100, e.g. when the storage is moved from a first location to a further location or if the storage changes its identity. Both, pull- and push-based solutions are possible for communicating the location S100 to the delivery service. For a pull-based solution, the delivery service D100 requests the delivery address to be sent to the delivery service D100. The pull-based solution thus requires that the delivery service D100 has an address like an address of a location based service from which an update on the delivery address can be requested. According to an example for a push-based solution, the delivery address is sent to delivery service D100 without an explicit request and requires an address of the delivery service D100 to be known to the delivery address pushing entity. The sending of the updated delivery address may be done in regular intervals, e.g. every 10 minutes, or event-triggered, e.g. whenever the delivery address is changed.

One solution to update the delivery service D100 with respect to the delivery address is that the customer C100 informs the delivery service D100 whenever the storage S120 changes its delivery address. However, this solution requires that the customer C100 is updated about the changes and is capable of forwarding, preferably promptly, an updated delivery address to the delivery service D100. According to further solution, the storage S120 and/or the lock system S110 are locatable, e.g. by a GPS system or by a location based service of a mobile telecommunication system, and a change of the location of the storage S120 and the lock system S10 is communicated to the delivery service D100 whenever they are moved. For example the storage and/or lock system can comprise a mobile phone, which is locatable by a location based service of a mobile telecommunication system like a GSM, GPRS, or UMTS. Alternatively or in addition, said communication device may comprise or be connected to a Global Positioning System (GPS) module, which allows a more precise determination of the location S100. The determined location information may be provided from the storage and/or lock system having mobile phone functionality directly or via a location based service to the delivery service either by a push- or pull-based implementation.

Furthermore, a step-wise provision of the delivery address to the delivery service D100 can be arranged, which can be preferable from a privacy or flexibility point of view. For routing planning, a coarse delivery address can be specified to the delivery service D100 e.g. before the transport of the good starts. During traveling, the delivery address may be updated by a specification of a precise delivery address that allows the delivery service D100 to precisely locate and identify the storage S120. An example for a coarse delivery address may be the name or the geographical specification of an area like a district of a town where the storage S120 is located. When the delivery service approaches to said coarse delivery address, e.g. enters said area, the precise delivery address can be communicated to the delivery service using push- or pull mechanisms as described before. A step-wise provision can thus achieve that the location S100 of the storage S120/lock system S10 can change within the range of the coarse delivery without compromising the routing planning and the delivery of the good.

A coarse location of the storage S120 can be sent by the customer C100 to the delivery service D100, e.g. via the merchant M100, when ordering the good. In addition, the customer may specify to the delivery service an address of a service where the delivery service can request the precise location. The service may be adapted to verify certain restriction information for restricting the provision of the precise location according to the preferences of the customer C100, e.g. the service may verify that the precise location is only provided to the delivery service D100 being in specified relation to the coarse location. An example for such a service is a location-based service of a mobile communication system that releases the precise delivery address, e.g. precise location of the storage S120 and information allowing an information of the storage S120 like a car plate, only after verifying that the current location of the delivery service D100 matches to a location given by the coarse delivery address. Similarly, a pushed-based location based service may push the precise delivery address only after verifying that the delivery service D100 fulfills certain conditions.

Information for notifying the customer C100 can be given by the order 110, from a database of the merchant M100 or of the delivery service D100, can be communicated during transporting and/or can be obtained at the location S100, e.g. it can be printed on the storage S120 or lock system S110 or can be determined by the delivery service D100 at the location S100 by other means like reading out an address of the customer's communication device C110 from the storage S120 and/or the lock system S10 via wireless communication like RFID-tag, Bluetooth or IR or wired communication.

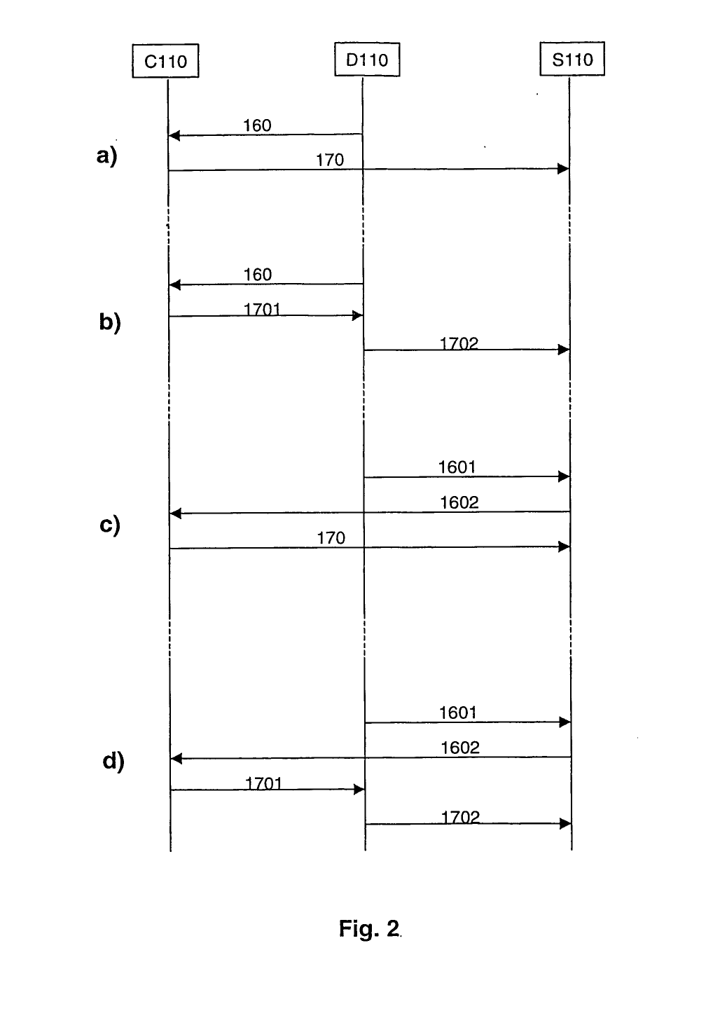

In the following, different embodiments are described for the notification and the remote unlocking as shown in FIG. 2. By the notification, the customer is informed that the delivery service requests the unlocking of the lock system for placing the good into the storage. A message for the notification is received by a communication device of the customer who can initiate the remote unlocking via the same communication device that received the notification message or via a further communication device by sending a message for unlocking via a mobile communication system to the lock system.

FIG. 2a) corresponds to the message exchange of FIG. 1 wherein a notification message 160 is sent from the communication device D110 of the delivery service to the communication device C110 of the customer. From communication device C110 the message 170 for remotely unlocking the lock system is sent via a mobile telecommunication system to the lock system S110 for unlocking the lock. This embodiment is very advantageous for lock systems comprising a receiver for a mobile telecommunication system.

According to FIG. 2b), the message 170 for unlocking is proxied via the communication device D110 of the delivery service, i.e. the message 170 for unlocking is sent from the communication device C110 of the customer to the lock system S110 via the communication device D110 of the delivery service by messages 1701 and 1702. An advantage is that the customer can communicate via its communication device C110 with the same communication device D110 for the notification and the unlocking.

According to FIG. 2c), the notification message 160 is proxied via the lock system S110, i.e. the notification message 160 is sent from the communication device D110 of the delivery service D100 via the lock system S10 to the communication device C110 of the customer by messages 1601 and 1602. Advantageous is that the customer can communicate via its communication device C110 with the same communication device, now lock system S110, for the notification and the unlocking. Another advantage is that the customer can stay more anonymous because no direct communication between the customer and the delivery service occurs in this example. Thus, for notifying the customer, the communication device D110 can communicate with the lock system S110 that can further extend the communication to the communication device C110 of the consumer.

FIG. 2d) shows another possible scenario proxying the notification message 160 and the message 170 for unlocking using notification messages 1601 and 1602 and unlock messages 1701 and 1702, respectively.

Communication between the communication device C110 of the customer and the lock system S110 is achieved via a mobile telecommunication system like GSM, GPRS, or UMTS giving the customer most flexibility with respect to his location in relation to the location of the lock system S110. Typically, the delivery service notifies the customer when approaching the storage. Accordingly the delivery service is also far away from the customer and information exchange between both entities preferably also involves information exchange via such a mobile telecommunication system providing maximum flexibility to the delivery service. For handing over the good, the delivery service is close to the storage and short range communication techniques are preferred for any kind of message exchange between the communication device of the delivery service and the lock system although in principle also communication via a mobile telecommunication system can take place. Examples for short range communication techniques comprise wireless transmission techniques like IR, Bluetooth, or other short range radio techniques, wired techniques like cable connections or inter-device contacting by electronic press contacts or plugs, or mechanical interaction via a key pad, or acoustical interaction via a loudspeaker or a microphone, or optical interaction. Referring to FIG. 2, messages 160, 1701, 1602, and 1701 are preferably sent via a mobile telecommunication system and messages 1601 and 1702 via short range communication techniques.

Correspondingly, direct and proxied message exchanges and communication technologies as described above can be used for a remotely controllable locking of the lock system S110, a remotely controllable opening, and/or remotely controllable closing of the storage S120. Further messages e.g. for confirming the unlocking of the lock system to the customer or for further supervision purpose can be also sent directly from the lock system S110 to the customer or proxied via the communication device D110 of the delivery service to the customer.

In the following, some preferred embodiments are described for illustrating the invention. In conjunction with the embodiments, security issues like authentication, authorization and/or supervision are considered that make the delivery method more secure. In the following embodiments the storage is the trunk of a car and the lock is an electronic lock of the car although the invention covers also further embodiments of a storage and a lock.

Next, a preferred embodiment is described wherein the lock system comprises a terminal connected to an electronic lock of a car. The terminal comprises a mobile transceiver and a processing unit capable of communicating via a mobile telecommunication system like GSM, GPRS, or UMTS. The terminal can be integrated as part of the car electronics, e.g. when manufacturing the car, or it may be a mobile phone connected to the electronic lock via a wired or a wireless connection. Unless an existing interface of an existing electronic lock like a IR port can be used for the connection of the terminal, the electronic lock has to be modified with a new interface for connecting the terminal and the electronic lock.

The delivery service can authenticate to the customer by providing information to the customer based on that the customer can verify the identity of the delivery service and/or the close proximity of the delivery service to the car. Authentication of the delivery service towards the customer can be thus for example achieved by sending a secret known by the customer and the delivery service and/or by sending a photo or video sequence taken by a mobile camera of the communication device of the delivery service showing an identification of the delivery service like an ID card and the customer's car. The latter proves also the close proximity of the delivery service to the car, which is of importance because it is not of advantage if the customer remotely unlocks the trunk if the delivery service is far away from the car.

Further solutions for proving the proximity of the delivery service and the car are conceivable. For example, a display can be comprised in or connected to the terminal, e.g. a display of a mobile phone may be used. The display displays a sequence of symbols like numbers, letters, pictures etc. changing over time which is visible to the delivery service. In addition, the sequence of numbers can be synchronized with the mobile phone of the customer via the terminal. The delivery service reads out the currently displayed sequence of symbols and communicates it to the customer e.g. in combination with the notification. At the customer, the sequence of symbols received from the delivery service is compared with the sequence of numbers synchronized with the terminal for proving the proximity of the delivery service. Evidence for the proximity of the delivery service and the storage/lock system is provided to the customer if the synchronized sequence and the sequence communicated from the delivery service match. Alternatively of using a display, the sequence of symbols may be transferred to the communication device of the delivery service via a further short range communication technique. The transferred sequence can be forwarded to the customer's communication device for comparison with the synchronized sequence.

Proving proximity may be also achieved by transferring a sequence of symbols from the customer via the terminal and the delivery service back to the customer using a short range communication technique for transferring the sequence from the terminal to the delivery service. For example, the sequence may be displayed or acoustically announced by the terminal and the delivery service types the announced sequence into its communication device in order to close the loop for the sequence. Alternatively or in addition, the round-trip of the sequence may be executed in the reversed orientation. In this case the short-range-transfer of the sequence from the communication device of the delivery service to the terminal may be achieved by entering the sequence into local input means comprised or attached to the terminal like a keypad for manual transfer or a microphone for an acoustic transfer. In a further example for proving the proximity, the customer may request the location of the terminal and the location of the communication device of the delivery service via location based service. If both locations match, the customer knows about the close proximity.

After describing ways for authentication the delivery service towards the customer, examples for an authentication of the customer towards the delivery service are given. By an authentication of the customer towards the delivery service the integrity of the customer can be proved to the delivery service, which is especially important for the delivery of valuable goods. As a first example the delivery service may check the car plate of the car for the identification of the customer. This check can be made by calling a third party service providing an appropriate verification service, e.g. providing an assertion that the customer according to whom the good is to be delivered to and the owner of the car match. Furthermore, the customer may authenticate to the delivery service by providing a secret to the delivery service, the secret known by both the delivery service and the customer. Another customer authentication example is a digital signature sent from the customer to the delivery service. The authentication of the customer towards the delivery service is executed preferably while the good is still under control of the delivery service, e.g. before the good is transferred into the trunk.

From a security point of view it can be beneficial that the customer and/or the delivery service authenticate to the lock system. An example for authenticating the customer towards the lock system is to send authentication information like a secret shared by the customer or the communication device of the customer and the lock system to the lock system. The lock system can check if the received authentication information matches to authentication information stored at database within the lock system or on a database accessible by the lock system. As the lock system and the customer are typically related, e.g. the lock system can be owned by the customer, the authentication information can be provided to the customer and the lock system when their relation is established. E.g. authentication information may be programmed into the lock system when fabricating the lock system and the related authentication information may be given to the customer when he acquires the lock system. However, the lock system can have an interface that allows a programming of the authentication information at a later stage. For authenticating the delivery service by the lock system, the customer may send authentication information to both the delivery service and the lock system, which at least temporarily stores the authentication in a database. Before unlocking the lock system, the lock system can verify that the authentication information received by the delivery service is entered into the lock system and that this information matches to the authentication information stored at least temporarily in the aforementioned database. If the authentication information is entered and matches, the authentication is accepted and the signal for unlocking the lock can be generated and communicated to the lock for unlocking the lock.

Next, mechanisms for unlocking the lock are described. For unlocking the lock, a key can be used that fits to the lock. In the context of the current invention, “key” is equivalent to information or code that effects the locking system to unlock the lock.

According to a first example, the customer uses a remote key of an electronic lock of a car. The remote key is a device that sends via short-range communication technique like IR a signal to the electronic lock for unlocking or locking the lock, e.g. of a trunk or a door. More advanced remote keys also allow to remotely open/close windows or the roof of a convertible which is regarded in the context of the invention equivalent to unlocking/locking the lock. The remote control key can be connected to a communication device of the customer that is capable to transmit messages via a mobile communication system. Such a device can be e.g. a mobile phone.

For unlocking the lock, the customer may activate a button at the remote key that triggers the remote key to send a signal for unlocking the electronic lock. Alternatively, instead of activating the unlocking at the remote key, the customer can use an application on his mobile phone that queries the remote key to send the signal for unlocking. However, as the electronic lock is far away, i.e. out of the transmission range of the remote key, this sending of the signal for unlocking does not have any impact on the electronic lock. Instead, the signal for unlocking is received by the mobile phone as a concrete example for the aforementioned communication device of the customer. Before the received signal for unlocking is communicated by a message via the mobile telecommunication system to the lock system for unlocking the lock, the received signal can be converted into a format that allows the sending via the mobile telecommunication system and the reception by the lock system. The lock system receives the message for unlocking from the communication device of the customer. The lock system can convert the received message into a signal compatible for the electronic lock. Subsequently, the signal is submitted to the electronic lock and the electronic lock is unlocked according to the signal.

For connecting the remote key and the communication device of the customer, preferably short-range communication techniques are used that are already present at both many remote keys and many mobile phones devices like IR. However, in order to achieve compatibility to all kind of remote keys and communication device, a standardized interface is recommended. A preferred solution is a Bluetooth interface which becomes more and more the de-facto standard for all kind of short range wireless communication. Connecting a remote key with a communication device like a mobile phone is thus a solution that can be easily implemented.

Alternatively to using a remote key being connectable to the mobile phone as described above, the communication device may have a build-in key, e.g. in form of a sequence of signals or code, that when send to the locking system triggers the locking system to unlock the lock. A build-in key can be realized by dedicated software operating on the communication device of the customer. An advantage is that the customer does not have to operate and connect two devices for the unlocking. Instead, the customer operates only one device that covers the functionality of a key and operates as a communication tool for communicating the key via the message for unlocking via the mobile telecommunication system to the locking system. In addition, incompatible interfaces of an external remote key and the communication device do not exist which both may make this solution preferable from the perspective of the customer.

The message for unlocking can be sent to the locking system directly, e.g. via message 170, or proxied, e.g. via messages 1701 and 1702. The direct communication requires that the lock system comprises a terminal as specified above. Direct communication between the communication device of the customer and the lock system is preferred from a security point of view as mobile communication systems provide very powerful authentication methods, i.e. the customer using a communication device with mobile phone functionality can reliably authenticate towards the terminal with mobile phone functionality and vice versa. In order to prevent an eavesdropping or interference of the signal generated by the terminal for unlocking the lock, the communication between the terminal and the lock is preferably protected, e.g. by using an appropriate wireless communication protocol or by a using a wired connection within the car.

For proxied communication between the communication device of the customer and the lock system, the message for unlocking is sent via the mobile telecommunication system to the delivery service. There, the received message can be forwarded to the locking system using short-range communication technique which requires compatible interfaces at the lock system and the communication device of the delivery service. As for the sending side, a preferred solution uses a standardized interface that eases connectivity for the deliver service and the lock system, e.g. Bluetooth.

According to a proxied solution, the delivery service receives the message for unlocking and is thus provided with a key for unlocking the electronic lock. In order to prevent the delivery service from unauthorized usage of the key, e.g. reusing the key or distributing the key to further entities, security requirements have to be tougher. A solution preventing the delivery service from unauthorized usage of the key is to restrict the usage of the key to a limit, preferably a one time usage. For this reason it may be of advantage to associate the key with identification information based on that it can be checked if and how often the key has been used. Another restriction that can be used alternatively or in addition is a temporal restriction of the usage like usage of key allowed within a time-interval, e.g. 30 sec. after sending of the message for unlocking. Another restriction can be a local restriction, e.g. restricting the usage of the key to the current location of the lock system. In order to prevent the delivery service from tampering with the message for unlocking, the message respectively its content is preferably encrypted with a key that is decryptable by the lock system comprising e.g. a processing unit being adapted for adequate decryption. Public key infrastructure (PKI) or other encryption mechanisms may be used for encryption and decryption of messages between the customer and the lock system. Thus, the message for unlocking comprises preferably a key for unlocking the lock and restriction information restricting its usage as explained before, both being preferably encrypted. The message for unlocking is then forwarded via appropriate short-range communication like Bluetooth to the lock system where it can be decrypted in a processor of the lock system. The key can be accompanied by authorization information confirming to the lock system that the delivery service is authorized to operate the lock with the provided key. For verifying the authorization, the lock system may request the delivery service to authenticate towards the lock system.

The restriction, authentication, and/or authorization information can be verified and if determined as valid the processing unit generates a signal for unlocking based on the key that triggers the lock to be unlocked. Verification of restriction, authentication, and authorization information may be done “on-board”, i.e. within the lock system, or with the help of an external service provider. An example for on-board verification is a verification of a temporal restriction where the processor of the locking system may determine the time the message for unlocking was received from the delivery service, e.g. via using a build-in clock, and to compare this determined time with the specified temporal restriction. An example for a verification of a local restriction would be to determine the location of the locking system, e.g. via a location based service or a GPS receiver within the car, and to compare it with the location restriction specified in the message for unlocking. Verification of a usage limit may by based on checking the identification information associated with the key with a history database. In the history database, the locking system stores the identification, information of the keys used in previous unlocking sessions. If a new message for unlocking arrives at the locking system, the locking system determines the identification information from the new message and compares the identification information with the history if the key has been used before. If it has not been used before, it can immediately generate a signal for unlocking the lock. If it has been used before, it may check if the usage limit is exceeded and if so to deny the unlocking.

After unlocking the lock, the storage can be accessed, e.g. the delivery service can open the trunk and transfer the good into the trunk. Then, the storage is preferably closed and locked again. Closing may be mechanically achieved by the delivery service. The lock system may be configured such that it automatically locks when the storage is closed. Alternatively, the access time of the storage may be restricted, i.e. the time after the unlocking took place. Such an access restriction may be achieved by specifying a time interval like a maximum duration for the opening of the storage starting at the time of the unlocking of the lock. The lock system can be adapted such that it automatically closes the storage and locks the lock if the access time is exceeded. In a further solution, closing and/or locking may be achieved remotely. Messages and processes for the locking can be implemented in a corresponding manner as the messages and processes for the unlocking.

Preferably, the delivery is supervised. Supervision may cover all steps of the delivery or only particular steps. Supervision may be achieved by the delivery service e.g. it could use a mobile camera and record the delivery process, e.g. record the delivery service together with the car plate, the opening of the trunk, the placing of the good into the trunk, and the closing of the trunk for its own archive in order to later prove the delivery. In addition, the messages sent from or to the delivery service may be recorded and stored in the archive.

For the supervision of the delivery method for the customer, the delivery service may send online the recorded steps of the delivery to the customer. Alternatively, the customer may have a build in camera in his car that records the storage or parts thereof and optionally communicates the recorded information to the customer. Alternatively or in addition, supervision may be achieved by communicating status messages from the storage/lock system to the customer. For example, a confirmation message may be sent when the storage is closed or when the lock is locked. Or one or more detectors may be used that can register the placing of the good into the storage. Examples for a detector are a camera that can take a photo of the good in the storage or a weighing machine that registers if a good is transferred to the storage. The one or more detectors can register if the good is located in the trunk and can inform the customer about it. The lock system preferably comprises such a detector, e.g. the detector may be integrated or connected to the terminal and/or the electronic lock, because information recorded by the detector can thus be easily communicated via the lock system and no further communication device has to be introduced thus lowering implementation cost and complexity.

In general, supervision enhances the security. The information recorded e.g. as described above can be sent to the customer, the delivery service, and/or a trusted third party. The trusted third party may be e.g. a mobile operator that archives messages from the communication devices of the customer, the locking system, and/or the delivery service based on that the delivery (or non-delivery) can be proved online or later-on.

After reception of an indication that the good is within the closed and locked storage, the customer can be sure that the delivery successfully took place. If requested, the customer can remotely sign the handing over of the good. Remotely signing the handing over of the good to the delivery service may be achieved by sending a message (proxied or directly) comprising an electronic delivery note from the delivery service to the customer. The electronic delivery note can be signed with a digital signature and can be communicated in a further message (directly or proxied) to the delivery service.

Based on an indication that the good is successfully delivered, the customer can initiate payment of the good and/or of the delivery service. Such an indication can be the aforementioned electronic delivery note. Payment maybe executed via the phone bill of the customer's mobile phone.

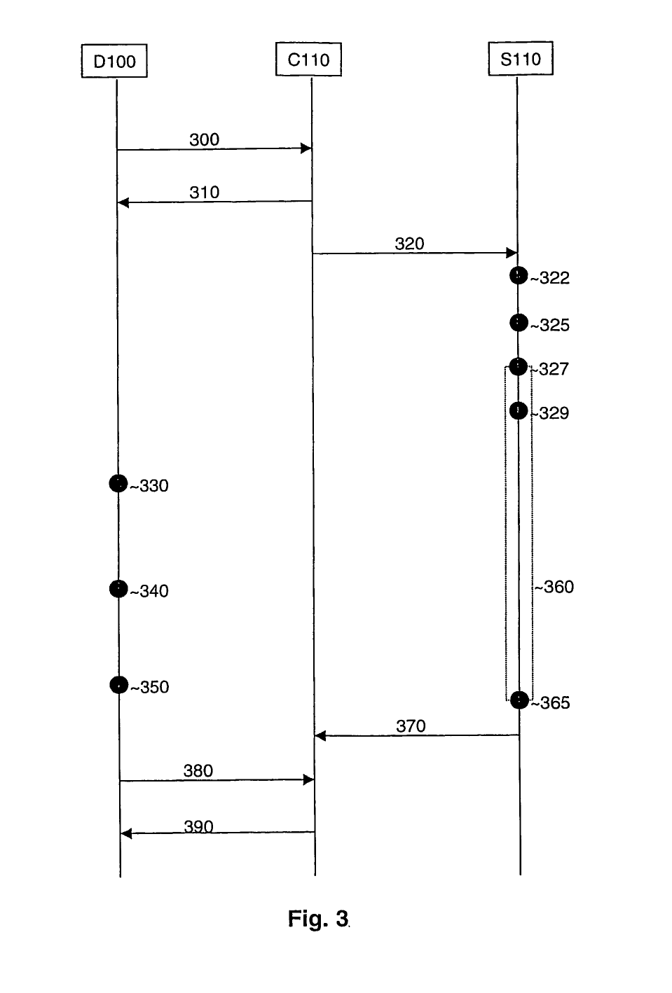

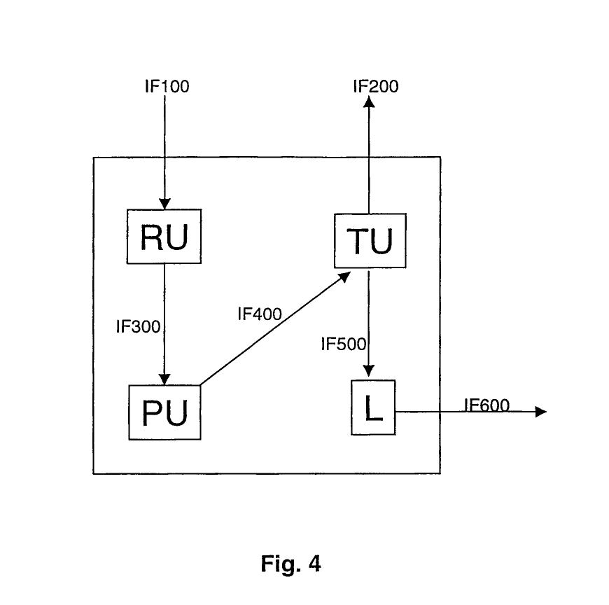

FIG. 3 depicts an embodiment of a delivery with authentication and supervision. Depicted are messages and processes exchanged between or carried out by the delivery service D100, the communication device C110 of the customer, and the lock system S110. FIG. 4) starts with message 300 comprising a notification for the customer that the delivery service D100 has just arrived at the customer's car with its trunk being locked by the lock system S110. The message 300 further comprises authentication information for authentication of the delivery service D100 to the customer, e.g. a photo of the deliverer together with the car plate of the customer's car and/or further authentication information like a secret delivery number or a delivery service identification information like a MSISDN of the delivery service D100. Furthermore, message 300 comprises a request for authentication of the customer to the delivery service D100. At the customer's communication device C110, the customer verifies the provided authentication information for authentication of the delivery service D100. Furthermore, the customer retrieves authentication information for authenticating towards the delivery service from a database of it's communication device C110 and/or enters authentication information into it's communication device C110 and sends the retrieved and/or entered authentication information via message 310 to the delivery service where it can be verified for authenticating the customer towards the delivery service D100.

After authenticating the delivery service D110 towards the customer, the customer remotely unlocks the lock system S110 by sending from its communication device C100 a message 320 for unlocking to the lock system S110. The message 320 comprises a key for unlocking the lock system and optionally restriction information for restricting the usage of the key e.g. to a local limit, a temporal limit, or to the number of usages. It may further comprise authentication and/or authorization information of the customer. In process 322, the lock system S110 verifies the received information and if the verification is successful it generates in process 325 a signal for unlocking the lock on base of the received key, e.g. it converts the key into a format being compatible for the appropriate operation of the lock. The signal for unlocking is sent to the lock in process 327 and based on said signal the lock is unlocked in process 329.

The delivery service D100 can recognize the unlocking of the storage, e.g. by a noise accompanying the unlocking or by an automatically opening of the storage or by receiving a notification message, e.g. via SMS, to the delivery service D100 for informing that the lock is unlocked and that the storage can be now accessed for the transfer of the good.

The opening of the storage is indicated by process 330, which is achieved according to the present example manually by the delivery service D100. Alternatively, the storage can be opened automatically, e.g. via an automatic door or lid opener triggered by the unlocking of the lock. According to a third alternative, the opening of the storage may be executed remotely by the first entity. In process step 340, the delivery service D100 transfers the good into the storage and closes e.g. manually the storage in process step 350 which effects the lock to be locked according to process 365.

Steps of the delivery method can be supervised. According to the present example, the signal for unlocking can trigger a camera mounted in the trunk to record the unlocking of the lock according to process 329, the opening of the storage according to process 330, the placing of the good into the opened storage according to process 340, the closing of the storage according to process 350, and the locking of the lock according to process 365. A signal indicating the locking may trigger the camera to stop the recording at the time of process step 365. For on-line supervision, the pictures and optionally sound recorded by the camera are immediately sent to the customer. Alternatively, the recorded sequence of pictures (with or without sound) or the last picture of the recorded delivery sequence showing the good in the locked storage can be sent to the customer after the recording stops, e.g. as shown via message 370 to the communication device C110 of the customer for indicating a successful delivery of the good for the customer. Sending only a single picture has the advantage of lower transmission effort and thus cost whereas the full sequence or samples of the full sequence may enhance the comfortableness for the customer due to the more complete supervision.

The delivery service D100 can send via message 380 an electronic delivery note to the customer's communication device S110 which can be digitally signed and returned to the delivery service D100 via message 390. Preferably, the customer's communication device C110 stores the electronic delivery note in a database internal or external to the device C110. Correspondingly, the signed electronic delivery note may be stored by the delivery service D100.

FIG. 4 depicts an embodiment of the locking system comprising a receiving unit RU, a transmission unit TU, a processing unit PU, and a lock L. It further comprises internal and external interfaces and connections for communication.

The receiving unit RU receives the message for remotely operating, e.g. unlocking or locking, the lock system via interface IF100. Messages received by the receiving unit RU are transferred via interface IF300 to the processing unit PU. In the processing unit PU, the messages can be processed and communicated via interface IF 400 to the transmission unit TU. For messages to be sent from the lock system to the communication device of the customer or the delivery service or any other external entities, interface IF 200 can be used. A signal for operating the lock L can be generated by the processing unit PU, which can be sent via interfaces IF400 and IF500 to the lock L. Based on the signal received by the lock L, the lock L can be operated accordingly, e.g. unlocked or locked. IF600 represents the interface of the lock L to the storage (not shown). This lock L can be any kind of lock usuable for e.g. locking and unlocking a storage, e.g. a bolt enclosed by a corresponding opening. When the lock is locked, the opening mechanically encloses the bolt. For unlocking the lock, the signal for unlocking can effect the bolt to be mechanically moved out of the opening or it can effect the opening to be adjusted in a way that it releases the bolt. The bolt can be attached to the trunk lid and the opening to the trunk body or vice versa. Another example for a lock is a magnetic lock wherein one part of the lock is attached to the trunk lid and the other part is attached to the trunk body. For locking the magnetic lock, the processing unit PU can send via interfaces IF400 and IF500 to the magnetic lock a signal that activates a current resulting in an attraction of the two lock parts due to magnetic force. For unlocking the magnetic lock, the processing unit can send a signal for unlocking to the lock that switches off the current and thus deactivates the magnetic attraction of the two lock parts.

The technical implementations of the receiving unit RU and the transmission unit TU depend on their communication technique. For messages received or sent directly via a mobile communication system, e.g. messages 160 or 1701, the receiving unit RU and the transmission unit TU comprise a receiver and a transmitter, respectively, that are adapted to communicate directly via a mobile telecommunication system, e.g. are a GSM, GPRS, or UMTS compatible receiver or transmitter, respectively. Furthermore, the processing unit PU is adapted to process messages and information for communication via such a mobile communication system.

For messages received or sent via short-range communication techniques, the receiving unit RU and the transmission unit TU comprise a receiver and transmitter, respectively, that are adapted to communicate via a short-range communication technique. Examples for messages received via a short-range communication technique are messages 1601 and 1702. Furthermore, the processing unit is adapted to process messages and information to communicate via one or more short-range communication techniques.

As numerous communication techniques are possible, the receiving unit RU and the transmission unit TUI can comprise multiple receivers and transmitters each being adapted to a single communication technique, e.g. the receiving unit may comprise a receiver for receiving the message for unlocking directly from the first entity and a second receiver for receiving the message for unlocking proxied via the second entity. Thus, for achieving the communication via the receiving unit RU and the transmission unit TU, the processing unit PU is preferably adapted to cope with the requirements of the actual communication technique. Thus, interfaces IF300 and IF400 can split into multiple physical and/or logical interfaces in case the receiving unit RU and/or the transmission unit TU comprise receivers and transmitters of different communication technique.

Furthermore, the signal for unlocking can be communicated from the processing unit PU via the transmission unit TU to the lock L via interfaces IF400 and IF500. The transmitter needed for communicating said signal to the lock L can be integrated in the processing unit PU such that the interface IF400 can be also an internal interface. Interfaces IF400 and IF500 are not restricted to the usage of the same communication technology, e.g. interface IF400 may be realized by a wired connection whereas interface IF500 may be a Bluetooth or IR connection requiring an appropriate receiver at the lock L for receiving the signal for the unlocking communicated to the lock L via interface IF500 (receiver for receiving the signal at the lock L not shown). A detector (not shown) can be attached to or included in the lock L and a detector signal indicating e.g. a status of the lock L like unlocked or locked, can be communicated from the lock L to the processing unit PU in response to the signal for unlocking.

Preferably, the receiving unit RU, the transmission unit TU, and the processing unit PU are part of a communication device with mobile phone functionality connected via short range communication technique, e.g. hardwired or wireless via Bluetooth or IR, to the electronic lock of the trunk of the customer's car as an example for a storage. Said communication device can be implemented permanently in the car, e.g. when manufacturing the car, or may be installed in a removable way, e.g. by mechanically fixing and electrically connecting the communication device via a cradle mounted in the car with the cradle having an interface to the electronic lock.

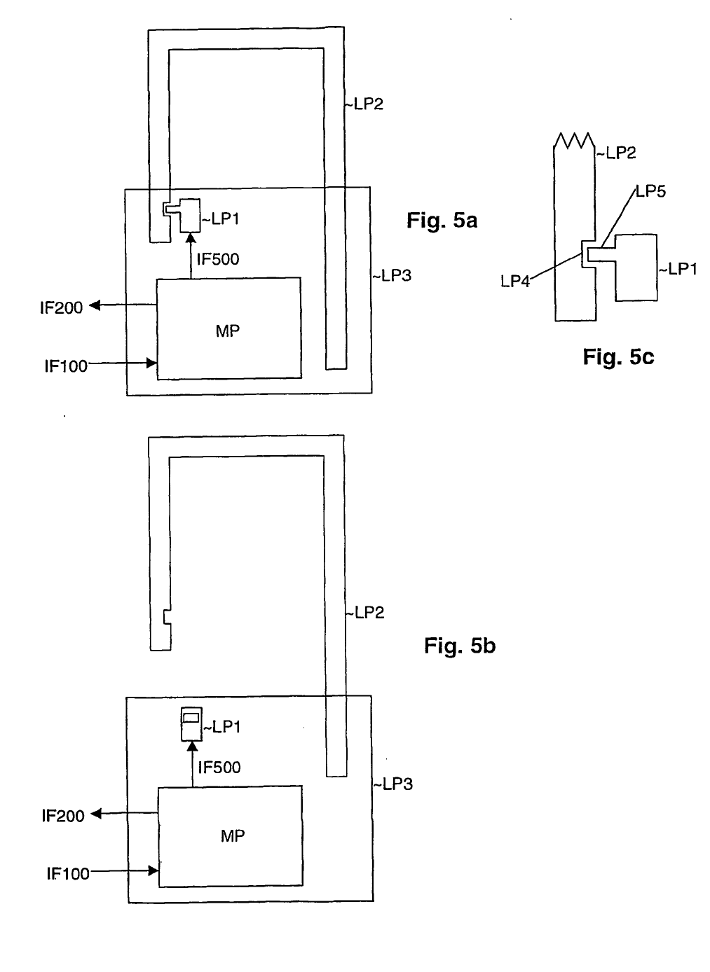

Referring now to FIG. 5 wherein a padlock as an example for a remotely controllable portable lock system according to the invention is depicted. The padlock comprises a communication device MP for exchanging messages and processing of messages and information. Furthermore, the padlock comprises a housing LP3 and further locking mechanics like a locking bow LP2, a notch LP4, and a movable bolting device LP1, which are given as example to illustrate the function of the remotely controllable padlock.

The locking bow LP2 can be used to attach the padlock to an entity (not shown in FIG. 5) that is to be locked, e.g. to the ends of a chain. According to the present example, the locking bow LP2 comprises at one of its ends the notch LP4. Furthermore, the exemplary padlock comprises a movable bolting device LP1 comprising a pin LP5 fitting into the notch LP4 as depicted. In locked status (FIGS. 5a and c), both ends of locking bow LP2 are (at least) partly comprised by the housing LP3 and the pin LP5 of the bolting device LP1 invades the notch LP4 for arresting the locking bow LP2 in locked position. For unlocking, the communication device receives via interface IF100 the message for unlocking and generates a signal for unlocking that is communicated via interface IF500 to the movable bolting device LP1. Based on the signal, the bolting device LP1 is moved from its locking position (Fig. a and c) to its unlocking position (FIG. 5b). According to the example of FIG. 5, the bolting device LP1 is rotated e.g. by 90° such that the pin LP5 no longer mechanically invade the notch LP4. Alternatively, the bolting device LP1 may be moved along the axis formed by the notch LP4 and the pin LP5 until the pin LP5 no longer invades the notch LP4. When the bolting device LP1 is in its unlocking position (FIG. 5b), the locking bow LP2 can be (at least partly as shown in FIG. 5b) removed from housing LP3 such that the locked entity can be released.

For a portable lock system an autonomous, preferably integrated power supply is of advantage compared to a solution wherein the lock system is electrically connected to an external power supply. Accordingly, the communication device MP and the battery are preferably enclosed by the housing LP3, which is as the locking bow LP2, the notch LP4 and the bolting device LP1 preferably made of a mechanically stable and chemically resistant material, e.g. locking bow LP2, notch LP4 and bolting device LP1 made of stainless steel and the housing LP3 made of brass. An encapsulation of the electric components like the communication device MP with battery by the housing LP3 can be beneficial as can protect the electric components from the environment, e.g. humidity and water, and improves the shock-resistance. However, if the communication device MP is encapsulated in a housing LP3 made of an electrically conductive material like e.g. brass or stainless steel, one or more appropriate openings in the housing LP3 must be foreseen for interfaces IF100 and IF200 to enable communication between the encapsulated communication device MP and to external entities like the customer and/or a delivery service. The receiving unit RU and the transmitting unit TU or parts thereof may be integrated in such an opening, e.g. an opening may comprise an antenna port. For environmental protection of encapsulated components, an opening can be covered by an appropriate non-conductive glue, non-conductive foil, and/or non-conductive plate etc.

1. A method for delivery of a good for a first entity, wherein the following steps are executed:
transporting the good by a second entity to a storage being locked by a lock system,
determining the location of the storage and/or the lock system,
communicating the determined location to the second entity in regular intervals or whenever the location of the storage and/or the lock system changes,
communicating a notification to the first entity for requesting an unlocking of the lock system for the second entity,
sending a message via a mobile telecommunication system from the first entity to the lock system for unlocking the lock system,
unlocking the lock system based on the received message,
opening the storage, and
transferring the good from the second entity to the opened storage.

2. The method according to claim 1, further comprising the step of communicating an address of the storage or the lock system to the second entity during the transport.

3. A method for obtaining a good from a first entity, wherein the following steps are executed:
a second entity traveling to a storage comprising the good, the storage being locked by a lock system,
determining the location of the storage or and/or the lock system
communicating the determined location to the second entity in regular intervals or whenever the location of the storage or the lock system changes,
communicating a notification to the first entity for requesting an unlocking of the lock system for the second entity,
sending a message via a mobile telecommunication system from the first entity to the lock system for unlocking the lock system,
unlocking the lock system based on the received message, opening the storage, and
transferring the good from the opened storage to the second entity.

4. The method according to claim 3, further comprising the step of communicating a delivery address related to the storage or the lock system to the second entity during the traveling.

5. The method according to claim 3, further comprising the step of obtaining, by the second entity, information for notifying the first entity from the storage or the lock system.

6. The method according to claim 3, further comprising the step of authenticating at least one of the first entity, the second entity, and the lock system for the unlocking.

7. The method according to claim 3, further comprising the step of verifying an authorization of at least one of the first and the second entity by the lock system for the unlocking.

8. The method according to claim 3, further comprising the step of verifying restriction information for the unlocking.

9. The method according to claim 3, further comprising the step of supervising one or more steps of the method for delivery.

10. The method according to claim 3, wherein the storage is an interior of a vehicle.

11. The method according to claim 3, wherein the storage is the trunk of a car.

12. The method according to claim 3, further comprising the step of remotely locking the lock system.

13. A Method for remotely controlling a lock system, the method comprising the steps of
determining the location of the lock system,
communicating the determined location to a second entity in regular
intervals or whenever the location of the lock system changes,
communicating a notification to a first entity for requesting an operation of the lock system for the second entity,
receiving at the lock system a message for operating a lock of the lock system, the message being received from the first entity via a mobile communication system,
generating by the lock system a signal for operating the lock according to the message, and
communicating the signal to the lock and operating the lock according to the signal.

14. The method according to claim 13, further comprising the step of authenticating the first entity or verifying an authorization of the first entity by the lock system for operating the lock.

15. The method according to claim 13, wherein the message is proxied via the second entity, the method further comprising the step of authenticating the second entity or and/or verifying an authorization of the second entity by the lock system for operating the lock.

16. The method according to claim 13, further comprising the step of verifying restriction information by the lock system for operating the lock.

17. The method according to claim 13, further comprising the steps of
receiving by the lock system from a detector a detector signal indicating information about the lock or about an environment of the lock,
generating by the lock system a further message based on the received detector signal for indicating said information to the first entity, and
communicating the further message to the first entity.

18. A remotely controllable lock system comprising
a receiving unit,
a transmission unit,
a processing unit,
a lock,
means to determine the location of the lock system,
means to communicate the determined location to a second entity in regular intervals or whenever the location of the lock system changes,
means for communicating a notification to a first entity for requesting an operation of the lock system for the second entity, the receiving unit being adapted to receive via a mobile telecommunication system a message from the first entity for operating the lock, the processing unit being adapted to process the message for generating a signal for operating the lock according to the message, and the transmission unit being adapted to communicate the signal to the lock and the lock being adapted to operate according to the signal.

19. The lock system according to claim 18, wherein the processing unit is adapted to generate the signal for operating the lock based on a key.

20. The lock system according to claim 18, wherein the processing unit is adapted to authenticate the first entity and to verify an authorization of the first entity for the operation.

21. The lock system according to claim 18, wherein the processing unit is adapted to verify restriction information for the operation.

22. The lock system according to claim 18, wherein the lock system further comprises a detector for a supervision of the lock or an environment of the lock.

23. The lock system according to claim 18, wherein the lock is a lock of a vehicle.

24. The lock system according to claim 18, wherein the lock system is portable.

25. The lock system according to claim 18, wherein the receiving unit, the processing unit, and the transmission unit are part of a communication device with mobile phone functionality.

26. (canceled)
